(19) United States
(12) Patent Application Publication
(10) Pub. No.: US 2024/0328440 A1
(43) Pub. Date: Oct. 3, 2024

(54) METHOD AND SYSTEM FOR CONTROLLING FLOW COMMANDS

(71) Applicant: CNH Industrial America LLC, New Holland, PA (US)

(72) Inventor: Joshua D. Zimmerman, Plainfield, IL (US)

(21) Appl. No.: 18/129,420

(22) Filed: Mar. 31, 2023

(51) Int. Cl. F15B 15/20; F15B 11/08; F15B 15/18; F15B 19/00

(52) U.S. Cl. CPC F15B 15/20; E02F 9/2235; E02F 9/2246; F15B 11/08; F15B 15/18; F15B 19/00; F15B 2211/6651; F15B 2211/6652

(57) ABSTRACT

The present disclosure describes a hydraulic control system for power loss prevention that includes at least one controller having a memory and a processor. The at least one controller is configured to determine an observed flow rate of hydraulic fluid at a hydraulic actuator based on an actuation speed of the hydraulic actuator. Additionally, the at least one controller may compare the observed flow rate to a commanded flow rate of the hydraulic fluid to the hydraulic actuator by a hydraulic pump of the hydraulic control system. Further, the at least one controller may adjust the commanded flow rate to a target flow rate in response to determining that a difference between the commanded flow rate and the observed flow rate is greater than a threshold value.

### BACKGROUND OF THE INVENTION

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Hydraulic systems may be used in various applications, such as within agricultural vehicles and implements, construction equipment, and so forth. Flow commands may be directed from a controller to a hydraulic pump to control a flow rate of hydraulic fluid to one or more actuators of the hydraulic system (e.g., hydraulic cylinder(s), hydraulic motor(s), etc.). Typically, a fluid relief valve is used in a hydraulic system to divert the hydraulic fluid to a tank when an excess amount of hydraulic fluid is detected. For example, an operator may command a high flow, but actuation of a hydraulic system actuator may be limited due to an excessive load on the actuator. Typically when this happens, the fluid relief valve opens and a portion of the commanded flow is diverted to the tank. The diversion of hydraulic fluid results in a power loss, which may prevent hydraulic power from being appropriately used by other actuators of the hydraulic system. In certain hydraulic systems, the pump may be pressure limited and automatically limit flow upon detecting a pressure that is greater than a threshold pressure for the hydraulic system.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, a hydraulic control system may include at least one controller that has a memory and a processor, where the at least one controller is configured to determine an observed flow rate of hydraulic fluid at a hydraulic actuator based on an actuation speed of the hydraulic actuator. The at least one controller may also compare the observed flow rate to a commanded flow rate of the hydraulic fluid to the hydraulic actuator by a hydraulic pump of the hydraulic control system. Further, the at least one controller may adjust the commanded flow rate to a target flow rate in response to determining that a difference between the commanded flow rate and the observed flow rate is greater than a threshold value.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that includes a hydraulic control system, in accordance with the present disclosure;

FIG. 2 is a schematic diagram of an embodiment of a hydraulic control system that may be used in the work vehicle of FIG. 1, in accordance with the present disclosure; and

FIG. 3 is a flow diagram of an embodiment of a method for controlling a hydraulic control system, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure relates generally to a method and system for controlling hydraulic flow and, more specifically, to adjusting hydraulic flow commands based on a difference between an observed flow rate of hydraulic fluid at a hydraulic actuator and a commanded flow rate of hydraulic fluid to the hydraulic actuator.

Certain agricultural vehicles, work vehicles, construction equipment, and the like include a hydraulic system that provides power to complete various tasks. These tasks may include loading, lifting, pushing, rotating, dozing, among others. In order to complete the various tasks, the hydraulic system may direct hydraulic fluid toward one or more hydraulic actuators. The hydraulic system includes a hydraulic pump to increase the pressure of the hydraulic fluid before directing it to one or more hydraulic actuators. The actuators may be used to move tools and/or wheels that are positioned a relatively substantial distance away from the hydraulic pump. The hydraulic actuators are configured to convert the high pressure of the hydraulic fluid from the hydraulic pump into linear and/or rotational mechanical motion. To control the fluid flow from the hydraulic pump to the hydraulic actuators, the operator may input a flow command to cause the hydraulic pump to generate a commanded flow rate for the task. However, the commanded flow rate may not be equal to the flow rate at the hydraulic actuator (e.g., the flow rate through a hydraulic motor, etc.). When the commanded flow rate is greater than the flow rate at the actuator, excess hydraulic fluid may be directed to a tank through one or more relief valves. Unfortunately, flowing excess hydraulic fluid across the relief valve(s) may result in a power loss and a lower overall efficiency of the hydraulic system. For example, the hydraulic pump consumes power that is wasted by flowing the hydraulic fluid through the relief valve(s).

For example, when operating one or more hydraulic actuators, the controller may instruct the hydraulic pump and/or an engine driving the hydraulic pump to deliver a larger amount of hydraulic fluid than is sufficient for operating the actuators. Excess fluid flow may be directed to the tank via the one or more relief valves. The excess fluid flow results in a power loss, as the engine output may be higher than the power sufficient to generate the flow rate sufficient for operating the actuators.

The disclosure below describes a hydraulic control system configured to reduce power loss from hydraulic fluid loss through the relief valve(s). As a result, the power efficiency of the hydraulic system is enhanced and, in certain embodiments, the relief valve(s) may be obviated. The hydraulic control system may be incorporated into the hydraulic system, or the hydraulic control system may be supplementary, such that the hydraulic control system may be added onto an already existing hydraulic system to improve power efficiency.

In certain embodiments, the hydraulic control system includes a controller that may receive an initial flow command from an input source indicative of instructions to cause a hydraulic pump to output a commanded flow rate. The hydraulic pump directs the commanded flow to one or more hydraulic actuators, where an observed flow rate is determined via one or more sensors. The sensor(s) may output signal(s) indicative of the observed flow rate back to the controller. The controller may then compare the observed flow rate at the hydraulic actuator(s) to the commanded flow rate directed to the hydraulic actuator(s). If the difference between flow rates is greater than a threshold value, the controller may adjust the commanded flow rate. The controller may adjust the commanded flow rate by adjusting the speed of an engine that drives the hydraulic pump and/or by adjusting the volume of the hydraulic pump. Controlling the hydraulic flow in this manner may reduce the amount of wasted fluid flow through the relief valve(s). For example, if a hydraulic actuator is operating in a condition that utilizes a flow rate of 100 liters per minute (l/min), and the flow command directs a commanded flow rate of 150 l/min to the actuator, traditional systems may lose power due to the 50 l/min lost through the relief valve(s). However, if the 50 l/min exceeds the threshold value of the presently described system, the controller may adjust the commanded flow rate to limit the amount of wasted hydraulic fluid. Following the previous example, the adjusted commanded flow rate (or target flow rate) may be reduced to 100 l/min or, in certain embodiments, a desired percentage over 100 l/min. In this way, hydraulic fluid lost via the relief valve(s) may be substantially reduced or eliminated.

In some embodiments, the target flow rate may include a leakage factor. The leakage factor accounts for inefficiencies in the hydraulic system and losses of hydraulic fluid through leaks. For example, if the target flow rate (e.g., 100 l/min) directed toward a hydraulic actuator were exactly equal to the fluid utilized by the hydraulic actuator (e.g., 100 l/min), but a leak in the fluid pathway resulted in a loss of hydraulic fluid of 2 l/min, the hydraulic actuator may not operate as desired. The leakage factor may take this leakage into account, such that the target flow rate is greater than the observed flow rate (e.g., by a desired percentage). For example, the leakage factor may be selected such that the target flow rate is 10 percent (e.g., 10 l/min) higher than the observed flow rate, thereby enabling the hydraulic actuator to operate at a maximum capacity (e.g., maximum capacity based on the operating conditions). In this example, the target flow rate may be 110 l/min to compensate for the 2 l/min leakage and any other leaks that may exist, while enabling the hydraulic actuator to operate at 100 l/min.

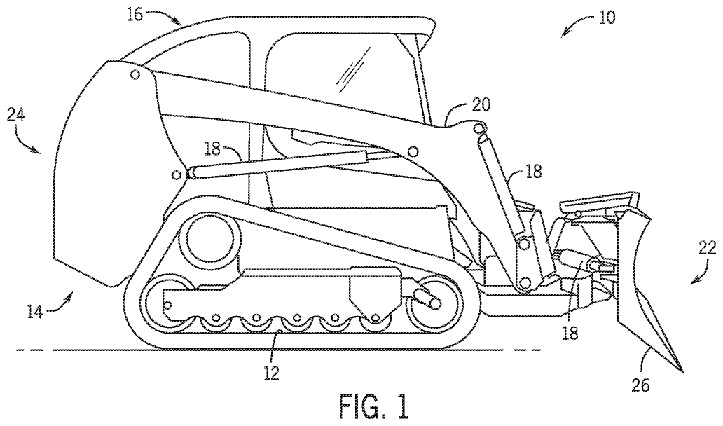

FIG. 1 is a side view of an embodiment of a work vehicle 10 (e.g., a skid steer, a compact track loader). The work vehicle 10 includes tracks 12 that enable the work vehicle 10 to move. The work vehicle 10 includes an engine 14 that provides power to the tracks 12, as well as power to other systems on the work vehicle 10. Systems that receive power from the engine 14 may include a hydraulic control system 16, an electrical system, a climate control system, among others. The hydraulic control system 16 may include one or more hydraulic actuators 18 (e.g., hydraulic cylinders, hydraulic motors, etc.). In the illustrated embodiment, the hydraulic control system 16 includes hydraulic actuators 18 that control operation an arm 20 (e.g., boom). In some embodiments, the hydraulic control system 16 may have sensor(s) (e.g., disposed within the hydraulic actuator(s) 18) configured to output sensor signal(s) indicative of actuation speed(s) of the hydraulic actuator(s). The hydraulic control system 16 may also include the engine and a hydraulic pump which may be fluidly connected to the hydraulic actuators 18 via one or more flow paths. The arm 20 is coupled to a tool 22 that enables the work vehicle 10 to perform various tasks. In the illustrated embodiment, the tool 22 is a dozer blade. However, in other embodiments, the tool may be a fork, a bucket, or a plow, among others. Each of these tools enable the work vehicle 10 to perform one or more tasks, such as loading, dozing, etc. To control the position of the tool 22, the work vehicle 10 may control hydraulic fluid flow to the hydraulic control system 16 which controls operation of the hydraulic actuators 18. While the work vehicle includes tracks 12 in the illustrated embodiment, in other embodiments, the work vehicle may include wheels or a combination of wheels and tracks. The hydraulic control system 16 may control operation of one or more hydraulic motors that drive the tracks 12 to rotate.

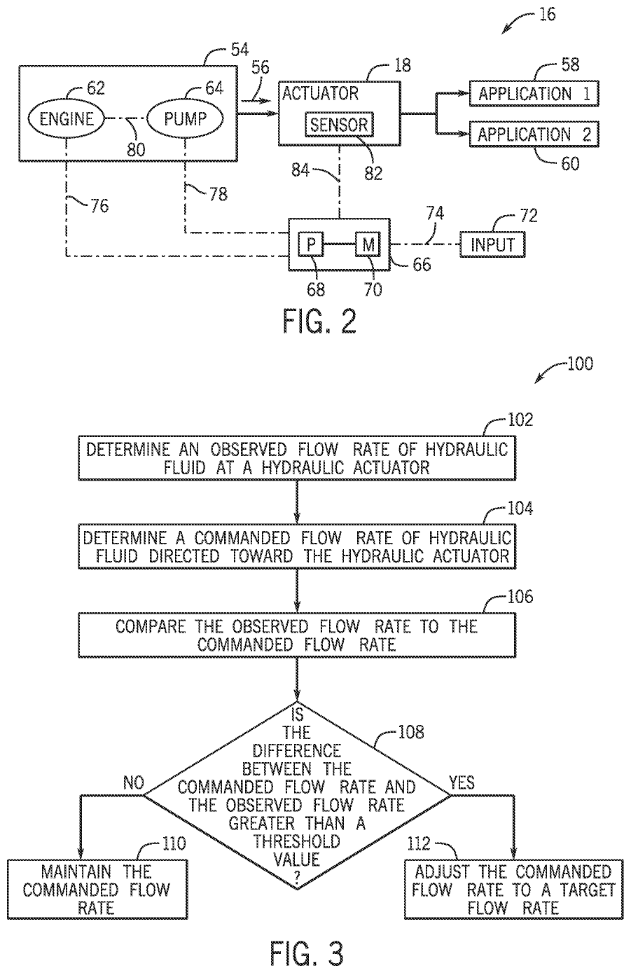

FIG. 2 is a schematic diagram of an embodiment of a hydraulic control system 16 that may be employed within the work vehicle of FIG. 1, in which the hydraulic control system 16 controls operation of one or more hydraulic actuators 18. As discussed in detail below, a hydraulic source 54 outputs hydraulic fluid to the hydraulic actuators 18 along a flow direction 56. As previously discussed, the hydraulic actuator(s) 18 may include hydraulic cylinder(s) and/or hydraulic motor(s).

As explained above, the work vehicle may use hydraulic actuators 18 to perform various tasks such as task or application one (block 58) and task or application two (block 60). The work vehicle may perform a number of tasks or applications (e.g., two, three, four, five, etc.) that may involve different hydraulic fluid flow rates and/or control resolutions. For example, some work vehicles may operate both as a loader and as a dozer. That is, the work vehicle may switch back and forth between a loading mode and a dozing mode. The operator may desire different control resolutions depending on the mode of operation. For example, in a loading mode (e.g., application one 58) the operator may desire rapid actuation of the hydraulic actuator(s) 18 in exchange for less precise control over the movements of the hydraulic actuator(s) 18. In a dozing mode (e.g., application two 60), the operator may exchange a slower response for more precise control over the movements of the hydraulic actuator(s) 18. The difference in control and speed of actuation is controlled using different amounts of hydraulic fluid supplied to the hydraulic actuator(s) 18 at different flow rates (e.g., commanded flow rates). For example, a first commanded flow rate may be a high flow rate, which enables a rapid response from the hydraulic actuator(s) 18, but with a lower control resolution. A second commanded flow rate may be a low flow rate, which enables a higher control resolution, but with a slower response.

In some embodiments, the hydraulic source 54 includes an engine 62 and a hydraulic pump 64. The engine 62 may drive the hydraulic pump 64 to convert rotary motion of the engine 62 into hydraulic pressure and flow. The hydraulic fluid pressurized by the hydraulic pump 64 may then be used to drive the hydraulic actuator(s) 18. In some embodiments, the hydraulic actuator(s) 18 may include linear actuator(s) (e.g., hydraulic cylinder(s)). Accordingly, the pressurized hydraulic fluid may generate linear mechanical motion. In some embodiments, the hydraulic actuator(s) 18 may include rotary actuator(s) (e.g., hydraulic motor(s)). Accordingly, the pressurized hydraulic fluid may generate rotational mechanical motion. The hydraulic source 54 may be operated over a wide range of flow rates and pressures. For example, the engine 62 may be controlled (e.g., via flow commands) to control the speed of the hydraulic pump 64, thereby controlling the hydraulic fluid flow rate (e.g., commanded flow rate) and the hydraulic fluid pressure. In addition, the hydraulic pump may include a swash plate that has an adjustable tilt, such that the angle of the swash plate may be controlled. In some embodiments, flow commands delivered to the hydraulic source 54 may instruct the swash plate to change an angle with respect to the hydraulic pump 64 to increase or decrease the volume of the hydraulic pump 64. In some embodiments, the hydraulic pump 64 may be reversible through tilting the swash plate in opposite directions. Accordingly, the direction of flow 56, the flow rate of the hydraulic fluid (e.g., the commanded flow rate), and the hydraulic fluid pressure may be controlled by adjusting the angle of the swash plate of the hydraulic pump 64.

To provide the desired flow rate (e.g., commanded flow rate), the hydraulic control system 16 includes a controller 66. The controller 66 includes a processor 68 and a memory 70. For example, the processor 68 may be a microprocessor that executes software that enables control of the engine 62 and the hydraulic pump 64. The processor 68 may include multiple microprocessors, one or more “general-purpose” microprocessors, one or more special-purpose microprocessors, and/or one or more application specific integrated circuits (ASICs), field-programmable gate arrays (FPGAs), or some combination thereof. For example, the processor 68 may include one or more reduced instruction set computer (RISC) processors.

The memory 70 may include a volatile memory, such as random access memory (RAM), and/or a nonvolatile memory, such as read-only memory (ROM). The memory 70 may store a variety of information and may be used for various purposes. For example, the memory 70 may store processor executable instructions, such as firmware or software, for the processor 68 to execute. The memory 70 may include ROM, flash memory, a hard drive, or any other suitable optical, magnetic, or solid-state storage medium, or a combination thereof. The memory 70 may store data, instructions, and any other suitable data.

The controller 66 is communicatively coupled to and receives input (e.g., flow commands) from an input device or input system 72. In some embodiments, the input system 72 and the controller 66 are in digital communication via a first data pathway 74, such that the flow commands are transmitted to the controller 66 via an input data set. The input data set may include actions and operations corresponding to specific functions of the hydraulic control system 16. For example, the input system 72 may include a joystick, a touchscreen, levers, buttons, or a combination thereof, that provides output to the controller 66 indicative of the commanded flow rate (e.g., for a particular application). In certain embodiments, an operator may push a button on the input system 72 indicative of a particular application (e.g., application one 58, application two 60). In response, the controller 66 controls operation of the engine 62 and the hydraulic pump 64 based on the application/mode of operation. In some embodiments, the controller 66 may determine the desired application by detecting the position of the joystick and/or the change in the position of the joystick with respect to time. For example, a rapid movement of the joystick may be indicative of a quick response. The controller 66 may, therefore, control the engine 62 to increase the engine speed and/or control the hydraulic pump 64 to increase the volume to provide a higher flow rate of hydraulic fluid to the hydraulic actuator(s) 18. Furthermore, a slow movement of the joystick may be indicative of a precise movement control. The controller 66 may, therefore, control the engine 62 to decrease the engine speed and/or control the hydraulic pump 64 to decrease the volume to facilitate more precise control of the hydraulic actuator(s) 18. In some other embodiments, the controller 66 may determine the desired application based on an amount of deflection of the joystick. For example, an input that results in a higher deflection of the joystick from its resting position may be indicative of a quick response. An input that results in a lower deflection of the joystick from its resting position may associated with a precise movement control. In some embodiments, an operator may desire a training mode of operation that provides precise control of the hydraulic actuators 52. The controller 66 receives this signal from the input system 72 and in response controls the engine 62 and the hydraulic pump 64 to provide the desired level of control.

To receive and direct commands and data to and from the controller 66, the controller 66 and the other elements of the hydraulic control system 16 (e.g., the engine 62, the hydraulic pump 64, the input system 72) may be in digital communication.

To communicate a flow command to the engine 62 to change the engine speed, the controller 66 and the engine 62 may be in digital communication via a second data pathway 76. Similarly, the controller 66 and the hydraulic pump 64 may be in digital communication via a third data pathway 78 to communicate a flow command that may include instructions to adjust the volume of the hydraulic pump 64. In some embodiments, the engine 62 and the hydraulic pump 64 may be in digital communication via a fourth data pathway 80 to enable flow commands to adjust one or more of the engine 62 and the hydraulic pump 64. For example, if the hydraulic pump 64 is instructed via a first flow command to establish a volume of 100 liters per minute and a second flow command instructs the engine 62 to operate at an engine speed that would cause the hydraulic pump 64 to exceed 100 liters per minute, the commands may be adjusted to establish the desired flow rate (e.g., commanded flow rate).

In the illustrated embodiment, the hydraulic control system 16 includes at least one sensor 82 disposed at (e.g., within) at least one respective hydraulic actuator 18. The sensor 82 may measure position, velocity, acceleration, or a combination thereof, of at least one element (e.g., piston, shaft, etc.) of the hydraulic actuator 18. In some embodiments, the sensor 82 may be one of a set of sensors, and each sensor 82 may be configured to measure one of position, velocity, or acceleration of the at least one element of the hydraulic actuator 18. In some embodiments, the sensor 82 may be disposed within the hydraulic actuator 18, such that the sensor 82 makes physical contact with the at least one element. The sensor 82 may also be configured to measure fluid properties of the hydraulic fluid, such as density, temperature, corrosiveness, viscosity, chemical composition, and the like. The sensor 82 may be in digital communication with the controller 66 via a fifth data pathway 84. The fifth data pathway 84 may enable the sensor 82 to output data indicative of the actuation speed of the hydraulic actuator 18 to determine a flow rate of the hydraulic fluid at the hydraulic actuator 18 (e.g., the observed flow rate) to the controller 66. The fifth data pathway 84 may be two-directional and enable the controller 66 to output commands to the sensor 82. The sensor commands may include instructions to begin outputting data, instructions to stop outputting data, instructions with regard to the type of data the sensor 82 is to output, instructions to change the position of the sensor 82, and the like.

FIG. 3 is a flow diagram of an embodiment of a method 100 for controlling a hydraulic control system. First, the method 100 includes determining (at block 102), via the controller, an observed flow rate of hydraulic fluid at a hydraulic actuator based on an actuation speed of the hydraulic actuator. Prior to determining 102 the observed flow rate, a sensor signal from the sensor may be received by the controller via the fifth data pathway. The sensor signal may be indicative of the actuation speed of the hydraulic actuator. As previously discussed, the sensor may be configured to measure position, velocity, acceleration, or a combination thereof, of at least one element of the hydraulic actuator (e.g., piston, shaft, etc.). Once received by the controller, the processor may perform operations in which the received data is converted into an observed flow rate. The observed flow rate may include a volumetric flow rate and/or a mass flow rate.

The controller may receive and/or store additional data indicative of measurement(s) of the hydraulic actuator. For example, with regard to a hydraulic cylinder, the controller may determine the volumetric flow rate based on a cross-sectional area of the piston (e.g., on the rod side and/or on the cap side) and the speed at which the piston is moving relative to the cylinder. With regard to a hydraulic motor, the controller may determine the volumetric flow rate based on the volume of the hydraulic motor and the rotational speed of the motor shaft. The controller may also receive and/or store additional data indicative of the density of the hydraulic fluid in order to determine a mass flow rate. In some embodiments, the controller may continuously or cyclically determine the observed flow rate, such that the observed flow rate is repeatedly updated. In some embodiments, the sensor may output data for a period of time to enable the controller to determine the observed flow rate during that period of time. In some embodiments, the observed flow rate may be an average flow rate across the time in which the sensor is outputting the data. In this way, the controller may average variations to determine an observed flow rate with enhanced accuracy. In some embodiments, the observed flow rate may be an extremum (e.g., a maximum flow rate, a minimum flow rate) determined during the time period in which the sensor is outputting data. In this way, the controller may take into account flow rate fluctuations and outliers that may otherwise be ignored.

In certain embodiments, the controller may determine (at block 104) a commanded flow rate of the hydraulic fluid to the hydraulic actuator. Determining 104 the commanded flow rate may include receiving data indicative of the commanded flow rate of the hydraulic fluid to the hydraulic actuator from the hydraulic source. The commanded flow rate may be determined based on a speed of the engine of the hydraulic source, a volume of the hydraulic pump of the hydraulic source, or both. In some embodiments, a sensor (e.g., second sensor) may be disposed at the engine and configured to output data indicative of the speed of the engine. For example, the sensor may measure the rotary speed of the engine output shaft and output a sensor signal indicative of the engine speed to the controller via the second data pathway. Similarly, a sensor (e.g., third sensor) may be disposed at the hydraulic pump and configured to output data indicative of the volume of the hydraulic pump. For example, the sensor may be disposed at the swash plate of the pump, such that the total volume of fluid moved by the pump is monitored over time. This data may be output to the controller via the third data pathway. The controller may determine the commanded flow rate based on the engine speed, the hydraulic pump volume, or both.

In some embodiments, the commanded flow rate is determined via the flow command received from the input system, and the engine speed and hydraulic pump volume are used to determine a reference commanded flow rate. If the flow command indicates a commanded flow rate that is significantly different from the reference commanded flow rate determined from the measurements, the controller may output a warning via the first data pathway to the input system to alert the operator of a detected discrepancy. In some embodiments, the controller may adjust the displayed commanded flow rate to be equal to the determined reference commanded flow rate without input from the operator.

The controller may then compare (at block 106) the observed flow rate to the commanded flow rate. For example, the controller of the hydraulic control system may compare the observed flow rate, which is determined based on feedback from the sensor at the hydraulic actuator, to the commanded flow rate, which is determined based on the speed of the engine and/or the volume of the hydraulic pump of the hydraulic source. Comparing the two flow rates may include determining a difference between the observed flow rate and the commanded flow rate. In some embodiments, the observed flow rate may be subtracted from the commanded flow rate to determine a flow rate difference. In such an embodiment, a positive flow rate difference indicates the commanded flow rate is greater than the observed flow rate, and a negative flow rate difference indicates the commanded flow rate is less than the observed flow rate. A difference of zero may indicate that the observed flow rate and the commanded flow rates are equal.

The controller then makes a determination (at block 108) as to whether the difference between the commanded flow rate and the observed flow rate is greater than a threshold value. The threshold value may be determined by a manufacturer or operator and may remain constant throughout operation of the work vehicle. For example, the threshold value may be plus or minus 5 l/min of the commanded flow rate or the observed flow rate. The threshold value may also be plus or minus 10 l/min, 15 l/min, 20 l/min, or greater than 20 l/min. In some embodiments, the threshold value may dynamically change depending on the application of the work vehicle. For example, the threshold value may be plus or minus 5 l/min in a dozing application and plus or minus 10 l/min in a loading application. The threshold value may also be a percentage of the observed flow rate or the commanded flow rate, such that the threshold value is proportionate to the flow rate of hydraulic fluid. In some embodiments, the threshold value may be equal to zero. In some embodiments, the threshold value may be based on a leakage factor, which is described in further detail below.

In some embodiments, the controller may compare the absolute value of the difference to the threshold value. Therefore, the phrase “greater than” in block 108 does not exclude a negative difference obtained when the commanded flow rate is less than the observed flow rate.

In response to the difference between the commanded flow rate and the observed flow rate being less than the threshold value, the controller may maintain (at block 110) the commanded flow rate. A desired flow rate determined or received by the controller may be equivalent to the commanded flow rate. In this way, the commanded flow rate is unchanged by the controller, and the engine and hydraulic pump of the hydraulic source may not receive any new instructions.

In response to the difference between the commanded flow rate and the observed flow rate being greater than the threshold value, the controller may adjust (at block 112) the commanded flow rate to a target flow rate. Instructions associated with adjusting the commanded flow rate to the target flow rate may be output to the engine (e.g., an engine controller of the engine), the hydraulic pump, or both, to adjust the flow rate of the hydraulic fluid being directed from the hydraulic source to the hydraulic actuator. In some embodiments, the instructions output to the engine may include a target engine speed for the engine to operate, such that the hydraulic pump is driven at a speed to generate the target flow rate. In some embodiments, the instructions output to the hydraulic pump may include a target hydraulic pump volume. The pump volume may be adjusted via the swash plate described above by either increasing or decreasing the angle of the swash plate. The pump volume is adjusted in such a way that a target volume is established, which establishes the target flow rate. In some embodiments, the target flow rate may be greater than the commanded flow rate. In these embodiments, instructions to the hydraulic source from the controller may cause an increase in engine speed and an increase in volume of the hydraulic pump. In some embodiments, the target flow rate may be less than the commanded flow rate and the engine speed, the volume of the hydraulic pump, or both, may be decreased in order to lower the flow rate of hydraulic fluid.

In some embodiments, the target flow rate may be based, at least in part, on the observed flow rate. The target flow rate may be determined to reduce the commanded flow rate to substantially reduce or eliminate hydraulic fluid loss from the relief valve(s). Therefore, adjustments made to the commanded flow rate may reduce hydraulic fluid loss. In some embodiments, the target flow rate may be equal to the observed flow rate to substantially reduce or eliminate hydraulic fluid loss through the relief valve(s).

In some embodiments, the target flow rate may include a leakage factor. As described above, the leakage factor may account for possible leaks and losses of fluid within the hydraulic control system. The leaks may be caused by openings in fluid pathways, wearing of joints, components not being properly configured, and the like. In some embodiments, the leakage factor may be added to the observed flow rate to generate a target flow rate that is slightly greater than the observed flow rate. In this way, the hydraulic control system is able to provide a sufficient flow rate to the hydraulic actuator while accounting for losses of hydraulic fluid. Because the target flow rate may be slightly larger than the observed flow rate of the hydraulic actuator, the target flow may still generate some power loss via fluid loss through the relief valve(s). However, the amount of hydraulic fluid being wasted may be significantly reduced compared to typical hydraulic systems.

In some embodiments, a user may determine the leakage factor and input the leakage factor into the input system. For example, the leakage factor may be selected depending on the model of the work vehicle and/or operation conditions of the work vehicle. In some embodiments, the leakage factor may be a set value that does not change. For example, the leakage factor may be set to adjust the target flow rate to be a fixed flow rate greater than the observed flow rate. In some embodiments, the leakage factor may be a proportion of the target flow rate. For example, the leakage factor may be set at 10 percent of the observed flow rate so that the target flow rate (e.g., the observed flow rate plus the leakage factor) is 110 percent of the observed flow rate. The leakage factor may also be set at 5 percent, 15 percent, 20 percent, 25 percent, or a percentage greater than 25 percent. The corresponding flow rates may be 105 l/min, 115 l/min, 120 l/min, 125 l/min, or a flow rate greater than 125 l/min, respectively. In some embodiments, the leakage factor may be dynamic and change depending on the application. For example, the leakage factor may be a set value for a first application that utilizes a relatively high hydraulic fluid flow rate (e.g., 300 l/min), and the leakage factor may be a proportionate value (e.g., percentage of observed flow rate) for a second application that utilizes a relatively low hydraulic fluid flow rate (e.g., 10 l/min). In some embodiments, the controller may select a leakage factor that is the smaller of a set value and a proportionate value.

Employing the techniques disclosed herein may reduce the amount of power lost via fluid loss through the relief valve(s). For example, a traditional system may generate a commanded flow rate of 200 l/min to satisfy an application that utilizes 100 l/min, wasting an additional 100 l/min. Following the previous example, employing the method 100 may reduce the hydraulic fluid flow to a target flow rate of 110 l/min based on the observed flow rate (e.g., 100 l/m) and the leakage factor (10 l/min). In this way, the presently disclosed hydraulic control system may use about half the power. This power efficiency gain does not come at a loss to work vehicle functionality because the hydraulic actuator is receiving hydraulic fluid at a sufficient flow rate (e.g., at least 100 l/min).

While the method is disclosed with regard to a single actuator, the method may be applied to multiple actuators (e.g., concurrently, sequentially, etc.). For example, the hydraulic control system may receive a first set of data indicative of an actuation speed of a first hydraulic actuator and a second set of data indicative of an actuation speed of a second hydraulic actuator.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A hydraulic control system, comprising:
at least one controller having a memory and a processor, wherein the at least one controller is configured to:
determine an observed flow rate of hydraulic fluid at a hydraulic actuator based on an actuation speed of the hydraulic actuator;
compare the observed flow rate to a commanded flow rate of the hydraulic fluid to the hydraulic actuator by a hydraulic pump of the hydraulic control system; and
adjust the commanded flow rate to a target flow rate in response to determining that a difference between the commanded flow rate and the observed flow rate is greater than a threshold value.

2. The hydraulic control system of claim 1, comprising a sensor communicatively coupled to the at least one controller, wherein the sensor is configured to output a sensor signal indicative of the actuation speed of the hydraulic actuator.

3. The hydraulic control system of claim 2, wherein the sensor is disposed within the hydraulic actuator, and the sensor measures position, velocity, acceleration, or a combination thereof, of at least one element of the hydraulic actuator.

4. The hydraulic control system of claim 2, wherein the hydraulic actuator comprises a linear actuator comprising a piston, and the actuation speed monitored by the sensor comprises a linear speed of the piston.

5. The hydraulic control system of claim 2, wherein the hydraulic actuator comprises a rotary actuator comprising a motor shaft, and the actuation speed monitored by the sensor comprises a rotational speed of the motor shaft.

6. The hydraulic control system of claim 1, wherein the at least one controller is configured to determine the commanded flow rate based on a speed of an engine driving the hydraulic pump, a volume of the hydraulic pump, or a combination thereof.

7. The hydraulic control system of claim 1, wherein the target flow rate is based, at least in part, on the observed flow rate.

8. The hydraulic control system of claim 7, wherein the target flow rate is equal to a sum of the observed flow rate and a leakage factor.

9. The hydraulic control system of claim 8, wherein the leakage factor is ten percent of the observed flow rate.

10. The hydraulic control system of claim 1, wherein adjusting the commanded flow rate comprises adjusting a speed of an engine driving the hydraulic pump, adjusting a volume of the hydraulic pump, or a combination thereof.

11. A hydraulic control system, comprising:
a hydraulic actuator;
a hydraulic pump configured to output hydraulic fluid to the hydraulic actuator;
an engine configured to drive the hydraulic pump;
a sensor configured to output a sensor signal indicative of an actuation speed of the hydraulic actuator; and
at least one controller having a memory and a processor, wherein the at least one controller is communicatively coupled to the sensor, and the at least one controller is configured to:
determine an observed flow rate of the hydraulic fluid at the hydraulic actuator based on the actuation speed of the hydraulic actuator;
compare the observed flow rate to a commanded flow rate of the hydraulic fluid to the hydraulic actuator by the hydraulic pump; and
adjust the commanded flow rate to a target flow rate in response to determining that a difference between the commanded flow rate and the observed flow rate is greater than a threshold value.

12. The hydraulic control system of claim 11, wherein the hydraulic actuator comprises a linear actuator comprising a piston, and the actuation speed monitored by the sensor comprises a linear speed of the piston.

13. The hydraulic control system of claim 11, wherein the at least one controller is configured to determine the commanded flow rate based on a speed of the engine, a volume of the hydraulic pump, or a combination thereof.

14. The hydraulic control system of claim 11, wherein the target flow rate is based, at least in part, on the observed flow rate.

15. The hydraulic control system of claim 14, wherein the target flow rate is equal to a sum of the observed flow rate and a leakage factor.

16. The hydraulic control system of claim 11, wherein:
the at least one controller is communicatively coupled to the engine, and adjusting the commanded flow rate comprises adjusting a speed of the engine;
the at least one controller is communicatively coupled to the pump, and adjusting the commanded flow rate comprises adjusting a volume of the hydraulic pump; or
a combination thereof.

17. A method to control hydraulic fluid flow, comprising:
determining, via at least one controller comprising a memory and a processor, an observed flow rate of hydraulic fluid at a hydraulic actuator based on an actuation speed of the hydraulic actuator;
comparing, via the at least one controller, the observed flow rate to a commanded flow rate of the hydraulic fluid to the hydraulic actuator by a hydraulic pump; and
adjusting, via the at least one controller, the commanded flow rate to a target flow rate in response to determining that a difference between the commanded flow rate and the observed flow rate is greater than a threshold value.

18. The method of claim 17, comprising receiving, via the at least one controller, a sensor signal from a sensor indicative of the actuation speed of the hydraulic actuator.

19. The method of claim 17, comprising determining, via the at least one controller, the commanded flow rate based on a speed of an engine driving the hydraulic pump, a volume of the hydraulic pump, or a combination thereof.

20. The method of claim 17, wherein adjusting the commanded flow rate comprises adjusting a speed of an engine driving the hydraulic pump, adjusting a volume of the hydraulic pump, or a combination thereof.
